(19) United States
(12) Patent Application Publication
(10) Pub. No.: US 2008/0022372 A1
(43) Pub. Date: Jan. 24, 2008

(54) USER AUTHORITY MANAGEMENT SYSTEM AND METHOD FOR MANAGING USERS

(75) Inventors: YUN-FENG ZHANG, Shenzhen (CN); FU-SHUN HUANG, Tu-Cheng (TW); CHUN-LIN ZHOU, Shenzhen (CN); YANG HU, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/616,867

(22) Filed: Dec. 28, 2006

(30) Foreign Application Priority Data
Jun. 2, 2006 (TW) 95119640

(51) Int. Cl. H04L 9/32

(52) U.S. Cl. 726/4

(57) ABSTRACT

The method is used in a network system (60) and includes at least one client (30), a network (20), and a server (40). The method includes receiving user information from a user in the client; sending the user information to a server via the network; determining whether the user information is valid after the server receives the user information; searching user authority information corresponding to the user information if the user information is valid; sending the searched user authority information to the client; and setting a user authority according to the searched user authority information after the client receives the searched user authority information.

### BACKGROUND OF THE INVENTION

1. Field of the Invention

The invention relates to user authority management systems, and a user authority management system and a method for centrally managing various users.

2. Description of Related Art

Various network systems have a plurality of users. Each system includes a server and a plurality of terminals connected to the server. Each user has a respective authority for using the system through the terminal. For example, a manager of the system has a highest authority and can modify all parameters of the system. Engineers of the system can modify some of the parameters of the system. Workers can only read the parameters of the system. And thus, the system must be able to manage a variety of users.

Conventionally, user account information and user authority information are stored in the terminals, and not in the server. Thus, a manager of the system cannot centrally manage user account information and user authority information. Therefore, when user account information and user authority information of the system need to be updated, the manager must perform the updates at each terminal in the system containing the information to be updated.

Therefore, a heretofore unaddressed need exists in the industry to overcome the aforementioned deficiencies and inadequacies.

### SUMMARY OF THE INVENTION

An exemplary embodiment of the present invention provides a user authority management system used in a network system including at least one client and a server. The user authority management system includes a user interface (UI) module for receiving user information from a user, a first transceiver module for sending the user information to the server, a setting module for setting a user authority for operating the client, a storage module for storing account information, and user authority information therein, a determining module for determining if the user information matches the account information, a searching module for searching user authority information according to the user information, and a second transceiver module for sending the searched user authority information to the first transceiver module. The UI module, the first transceiver module, and the setting module are disposed in the client; the storage module, the determining module, the searching module, and the second transceiver module are disposed in the server.

Another exemplary embodiment of the present invention provides a method for managing various users. The method used in a network system includes at least one client, a network, and a server. The method includes receiving user information from a user of the client; sending the user information to a server via the network; determining whether the user information is valid after the server receives the user information; searching user authority information corresponding to the user information if the user information is valid; sending the searched user authority information to the client; and setting a user authority according to the searched user authority information after the client receives the searched user authority information.

Other advantages and novel features will become more apparent from the following detailed description when taken in conjunction with the accompanying drawings, in which:

### BRIEF DESCRIPTION OF THE DRAWINGS

FIG. 1 is a schematic diagram of an application environment of a user authority management system of an exemplary embodiment of the present invention;

FIG. 2 is a block diagram of the user authority management system of FIG. 1;

FIG. 3 is a flowchart of a method for managing users of another embodiment of the present invention; and

FIG. 4 is a detailed flowchart of step S309 of FIG. 3.

### DETAILED DESCRIPTION OF THE INVENTION

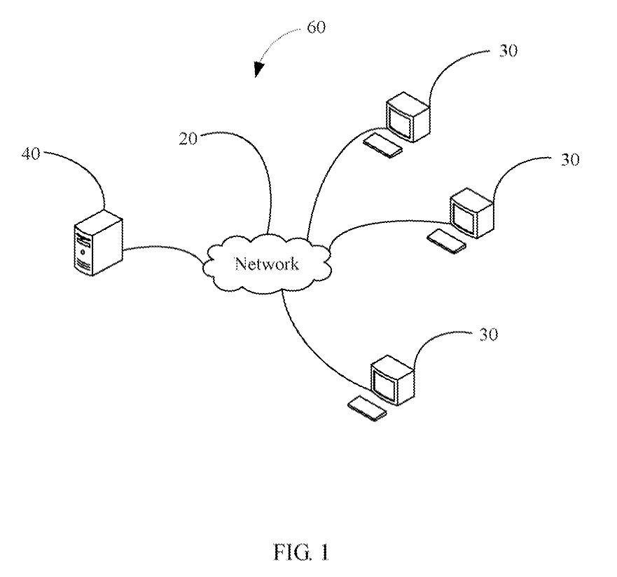

FIG. 1 is a schematic diagram of an application environment of a user authority management system 10 of an exemplary embodiment of the present invention. The user authority management system 10 is used in a network system 60. The network system 60 comprises a plurality of clients 30, a server 40, and a network 20. The clients 30 are connected to the server 40 via the network 20. In the exemplary embodiment, the clients 30 may be computers or other terminal devices with like function. The server 40 may be a computer or a workstation with enough storage capacity and high functionality. The network 20 may be a local area network (LAN) or an enterprise network.

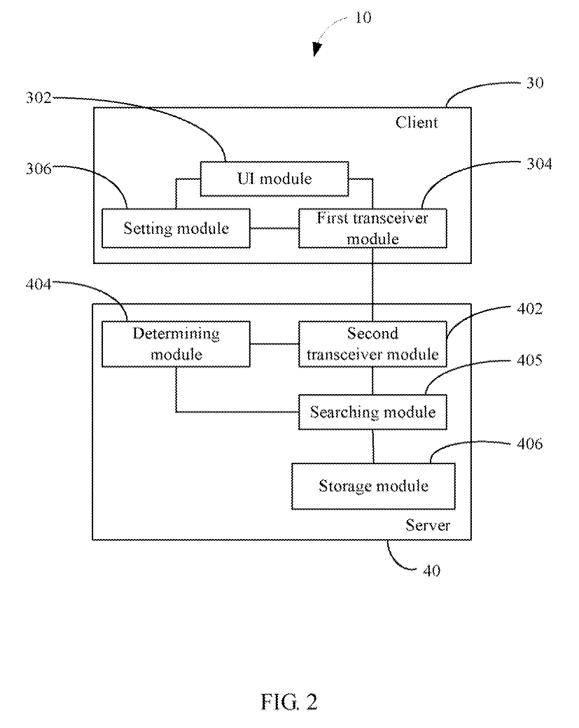

FIG. 2 is a block diagram of the user authority management system 10 of FIG. 1. The user authority management system 10 comprises a user interface (UI) module 302, a first transceiver module 304, a setting module 306, a storage module 406, a determining module 404, a searching module 405, and a second transceiver module 402.

The UI module 302, the first transceiver module 304, and the setting module 306 are disposed in the client 30; the storage module 406, the determining module 404, the searching module 405, and the second transceiver module 402 are disposed in the server 40.

The UI module 302 receives user information from a user of the client 30 and sends the received user information to the first transceiver module 304. The user information is stored in the first transceiver module 304. The user information comprises a user name and a password corresponding to the user name. The first transceiver module 304 sends the user information to the second transceiver module 402.

The storage module 406 stores account information and user authority information corresponding to the account information therein. The account information comprises a user name and a password corresponding to the user name. The user authority information comprises menu authority information and window authority information. The menu authority information and the window authority information respectively define operational authority for users operating the menus and the windows of software installed in the client 30. The account information and the user authority information are managed by a data management system such as Oracle, SQL server, or Powerbuilder and so on. In this way, the account information and the user authority information are stored in the server 40, thereby a manager of the network system 60 can centrally manage the various users.

The determining module 404 determines whether the user information is valid. In the embodiment, the determining module 404 compares the user information with the account information to determine whether the user information is valid. If the user name and the password of the user information are respectively match those of the account information, the user information is valid. Herein, if the user information is valid, the user information is designated as valid user information. If the user information is invalid, the user cannot use the client 30. In addition, when necessary, the determining module 404 determines whether the account information of the valid user information is locked. If the account information of the valid user information is locked, the user is designated as a locked user, and the locked user cannot use the client 30.

The searching module 405 searches user authority information according to the account information and sends the searched user authority information to the second transceiver module 402. The second transceiver module 402 sends the user authority information to the first transceiver module 304.

The first transceiver module 304 receives the user authority information and stores the user authority information therein. The setting module 306 sets a user authority for the user of the client 30 according to the user authority information stored in the first transceiver module 304. In the exemplary embodiment, the user authority for the user of the client 30 refers to the authority for the user operating the menus and the windows of software installed in the client 30. The user of the client 30 operates the client 30 in light of the user authority.

The first transceiver module 304 and the second transceiver module 402 call a library function of distributed component object model (DCOM) to establish a connection between the client 30 and the server 40. The connection is based on TCP/IP protocol. In an alternative embodiment, the connection may be based on IPX/SPX protocol. The searching module 405 calls a library function of component object model (COM) to search the user authority information.

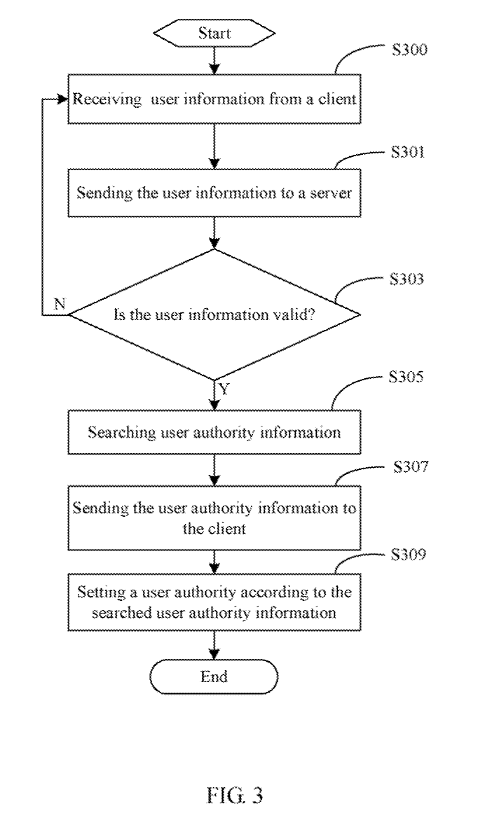

FIG. 3 is a flowchart of a method for managing various users of another exemplary embodiment of the present invention.

In step S300, the client 30 receives user information from a user. After the user information is received, the process proceeds to step S301.

In step S301, the client 30 sends the received user information to the server 40.

In step S303, the server 40 determines whether the user information from the client 30 is valid. In the exemplary embodiment, the server 40 compares the user information with the account information stored in the server 40 to determine whether the user information is valid. If the user name and the password of the user information respectively match those of the account information, the user information is valid. Herein, if the user information is valid, the user information is designated as valid user information. If the user information is invalid, the user cannot use the client 30. In addition, when necessary, the server 40 determines whether the account information of the valid user information is locked. If the account information of the valid user information is locked, the user is designated as a locked user, and the locked user cannot use the client 30. If the user information from the client 30 is valid, the process proceeds to step S305.

In step S305, the server 40 searches user authority information according to the user information.

If the user information from the user of the client 30 is invalid, the process proceeds to step S300, which is described above. That is, if the user information from the user of the client 30 is invalid, the client 30 is ready to receive other user information.

In step S307, the server 40 sends the searched user authority information to the client 30.

In step S309, the client 30 sets a user authority according to the searched user authority information. In this way, the user of the client 30 operates the client 30 according to the set user authority.

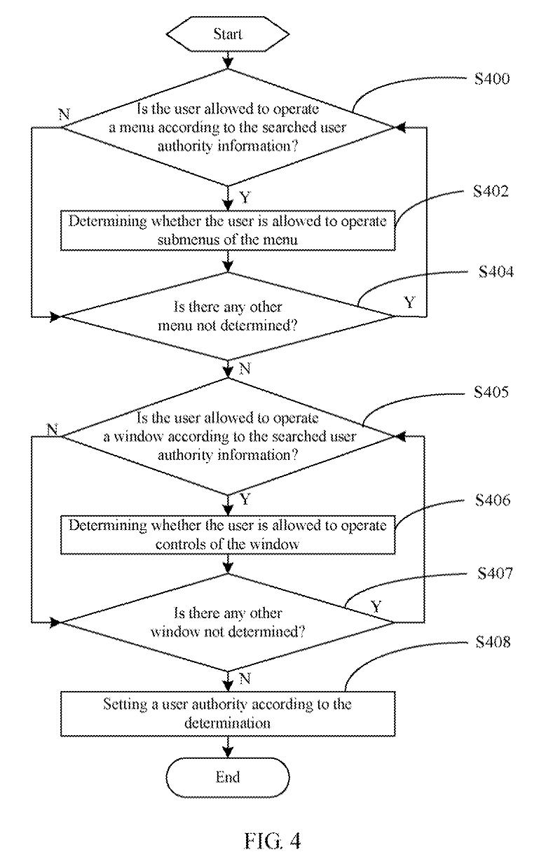

FIG. 4 is a detailed flowchart of step S309 of FIG. 3.

In step S400, the client 30 determines whether the user is allowed to operate a menu according to the searched user authority information. If the user is allowed to operate the menu, the process proceeds to step S402. Herein, if the user is allowed to operate the menu, the user is designated as a menu user.

In step S402, the client 30 determines whether the menu user is allowed to operate submenus of the menu if the user is a menu user, then the process proceeds to step S404.

If the user is not allowed to operate the menu, the process directly proceeds to step S404.

In step S404, the client 30 determines whether a determination has been made for all the menus. If not, then the process returns to step S400 described above.

If a determination has been made for all the menus, the process proceeds to the step S405.

In step S405, the client 30 determines whether the user is allowed to operate a window according to the searched user authority information. If the user is allowed to operate the window, the process proceeds to step S406. Herein, if the user is allowed to operate the window, the user is designated as a window user.

In step S406, the client 30 determines whether the window user is allowed to operate controls of the window, then the process proceeds to step S407.

If the user is not allowed to operate the window, the process directly proceeds to step S407.

In step S407, the client 30 determines whether a determination has been made for all the windows. If not, the process returns to step S405 described above.

If a determination has been made for all the windows, the process proceeds to the step S408.

In step S408, the client 30 sets a user authority according to the determinations.

With the user authority information and the account information being stored in the storage module 406 of the server 40, the user authority information and the account information are managed centrally, thus facilitating managing the account information and the user authority information, and increasing security of the network system 60.

While various embodiments and methods of the present invention have been described above, it should be understood that they have been presented by way of example only and not by way of limitation. Thus the breadth and scope of the present invention should not be limited by the above-described exemplary embodiments, but should be defined only in accordance with the following claims and their equivalents.

What is claimed is:

1. A user authority management system, used in a network system comprising at least one client and a server, the user authority management system comprising:
a user interface (UI) module, for receiving user information from a user of the at least one client;
a first transceiver module, for sending the user information to the server;
a setting module, for setting a user authority for operating the client;
a storage module, for storing account information and user authority information therein;
a determining module, for determining whether the user information matches the account information;
a searching module, for searching the user authority information according to the user information; and
a second transceiver module, for sending the searched user authority information to the first transceiver module;
wherein the UI module, the first transceiver module, and the setting module are disposed in the client; the storage module, the determining module, the searching module, and the second transceiver module are disposed in the server.

2. The user authority management system as claimed in claim 1, wherein the account information comprises a user name and a password corresponding to the user name.

3. The user authority management system as claimed in claim 1, wherein the user information comprises a user name and a password corresponding to the user name.

4. The user authority management system as claimed in claim 1, wherein the user authority information comprises menu authority information and window authority information, the menu authority information and the window authority information defining a user authority for operating the client.

5. A method for managing various users, used in a network system comprising at least one client, a network, and a server, the method comprising:
receiving user information from a user of the client;
sending the user information to a server via the network;
determining whether the user information is valid after the server receives the user information;
searching user authority information corresponding to the user information if the user information is valid;
sending a searched user authority information to the client; and
setting a user authority according to the searched user authority information after the client receives the searched user authority information.

6. The method as claimed in claim 5, further comprising:
returning to a state ready for receiving another user information if the user information is invalid.

7. The method as claimed in claim 5, wherein the user information comprises a user name and a password.

8. The method as claimed in claim 5, wherein the user authority information comprises menu authority information and window authority information, the menu authority information and the window authority information defining a user authority for operating the client.

9. The method as claimed in claim 8, wherein the step of setting user authority according to the searched user authority information after the client receives the searched user authority information comprises:
determining whether the user is allowed to operate a menu according to the searched user authority information;
determining whether the user is allowed to operate submenus of the menu if the user is allowed to operate the menu;
determining whether a determination has been made for all the menus; and
continuing to determine whether the user is allowed to operate any other menu according to the searched user authority information if a determination has not been made on one or more of the menus.

10. The method as claimed in claim 9, wherein the step of setting user authority according to the searched user authority information by the client after the client receives the searched user authority information further comprises:
determining whether the user is allowed to operate a window according to the searched user authority information if;
determining whether the user is allowed to operate controls of the window if the user is allowed to operate the window;
determining whether a determination has been made for all the windows; and
continuing to determine whether the user is allowed to operate any other window according to the searched user authority information if a determination has not been made for one or more of the windows.
